(19) United States
(12) Patent Application Publication
(10) Pub. No.: US 2024/0000071 A1
(43) Pub. Date: Jan. 4, 2024

(54) DEVICES, COMPOUNDS AND METHODS FOR INSECT CONTROL

(71) Applicant: Agriculture Victoria Services Pty Ltd, Bundoora (AU)

(72) Inventors: John Paul Cunningham, Ivanhoe (AU); Kevin Roland Robert Farnier, Mill Park (AU); Alexander Medway Piper, Thornbury (AU); Jessica Alexis Henneken, Heidelberg West (AU)

(21) Appl. No.: 18/037,211

(22) PCT Filed: Nov. 24, 2021
(86) PCT No.: PCT/AU2021/051397

§ 371 Date: May 16, 2023

(30) Foreign Application Priority Data
Nov. 25, 2020 (AU) 2020904364

(51) Int. Cl. A01N 25/18; A01N 37/02; A01N 43/16; A01P 19/00

(52) U.S. Cl. CPC A01N 25/18; A01N 37/02; A01N 43/16; A01P 19/00

(57) ABSTRACT

The present invention provides a composition for attracting a variety of fruit flies and related pests, said composition including short chain esters, long chain esters, alcohols and/or additional elements. The present invention also relates to apparatus for administering said composition, devices for attracting and trapping fruit flies and methods for use thereof.

### FIELD OF THE INVENTION

The present invention relates to devices, compositions and methods for insect control, more particularly for control of fruit flies. More particularly, the present invention relates to multicomponent compositions used in combination with devices for releasing said compositions and devices employing said compositions for attracting, trapping and/or monitoring insects, more particularly fruit flies.

### BACKGROUND OF THE INVENTION

Tephritid fruit fly species are recognised worldwide as some of the most damaging insect pests of many fruit and vegetable crops. Contamination and damage to crops typically occurs by adult female fruit fly laying eggs in the flesh of ripening and ripe fruits and vegetables. Once the eggs hatch, the larvae begin to feed within the crop.

Common methods for managing such pests typically include insecticide or chemical based cover sprays and protein bait sprays. However, such methods may result in damage or contamination of the crop, may have unfavourable environmental effects, and can be inefficient in pest control generally across different fruit fly species.

One example of a tephritid fruit fly pest is the Queensland fruit fly (Qfly), Bactrocera tryoni (Froggatt), a pest which inflicts damage to the Australian horticulture industry resulting in costs to the economy totalling tens of millions per year from yield losses, management and quarantine costs, and loss of domestic and international market access opportunities.

Methods to attract, trap and/or monitor male B. tryoni, are commonly performed through the use of the male parapheromone, cue-lure. However, these methods are only effective on males, with monitoring and trapping females being much more difficult to achieve. Female B. tryoni do not respond to cue-lure except under very limited circumstances, while the more commonly used liquid-protein and orange-ammonia traps for control of female B. tryoni are inefficient and/or logistically difficult to use and manage.

Chemical based lure systems for attracting male fruit flies, and protein baits for attracting female fruit flies, are used across various subfamily species of fruit flies. The lure systems for attracting male fruit flies have proven effective for monitoring purposes. Current systems for attracting female flies into traps have not yet been proven sufficiently effective as a control tool, for either monitoring or mass trapping purposes (i.e. reducing crop infestation or damage).

Whilst combinations of visual lures and chemical lures are known for mated female tephritid fruit flies, including visual lures impregnated with ammonia-based odours and coated with adhesive to which attracted fruit flies adhere, these are not widely adopted as they are considered only weakly attractive and ineffective as a control tool against female subsections of fruit fly species.

There exists a need to overcome, or at least alleviate, one or more of the difficulties or deficiencies associated with the prior art.

### SUMMARY OF THE INVENTION

In one aspect of the present invention there is provided a composition for attracting fruit flies, said composition including one or more short chain ester(s), and one or more further additives selected from:
long chain esters, and/or
alcohols,
   wherein said composition is a liquid and/or gas mixture.

By the term ester as used herein is meant an organic molecule having the general structure R—C(O)—OR′, wherein substituents R and R′ include carbon atoms.

By the term ‘composition’ as used herein is meant a mixture of additives which may be in the form of a liquid, gas, vapour or any other suitable phase mixture thereof which is capable of attracting fruit flies.

In a preferred embodiment the composition includes between 1 to 3 short chain esters. In a particularly preferred embodiment the composition include 3 short chain esters.

By the term ‘short chain esters’ as used herein is meant an ester with either substituents R, R′, or both combined, having equal to or less than 5 carbon atoms.

In a preferred embodiment each short chain ester contains from 3 to 6 carbon atoms. In a further preferred embodiment each short chain ester contains from 4 to 6 carbon atoms. In a particularly preferred embodiment the short chain esters are selected from the group consisting of ethyl acetate, ethyl propionate and ethyl butyrate; most preferably the composition includes ethyl acetate, ethyl propionate and ethyl butyrate.

In a preferred embodiment the composition includes between 1 to 3 long chain esters. In a particularly preferred embodiment the composition includes 3 long chain esters.

By the term ‘long chain esters’ as used herein is meant an ester with either substituents R, R′, or both combined, having 6 or more carbon atoms.

In a preferred embodiment each long chain ester contains from 7 to 10 carbon atoms. In a further preferred embodiment each long chain ester contains from 7 to 9 carbon atoms. In a particularly preferred embodiment the long chain esters are selected from the group consisting of hexyl acetate, ethyl hexanoate and (z)-3-hexenyl acetate; most preferably the composition includes hexyl acetate, ethyl hexanoate and (z)-3-hexenyl acetate.

In a preferred embodiment the composition includes between 1 to 3 alcohols. In a particularly preferred embodiment the composition includes 3 alcohols.

By the term ‘alcohol’ as used herein is meant an organic molecule having the general structure HO—R, wherein substituent R includes carbon atoms.

In a preferred embodiment the alcohol may be an alcohol produced by a fungus such as a yeast. For example, the alcohol may be a mixture of fungal volatiles. In a further preferred embodiment the alcohol may be an alcohol produced by a live yeast belonging to the genus Pichia, Hanseniaspora or any other suitable yeast genus. In a further preferred embodiment the alcohol may be an alcohol produced by a yeast species selected from Pichia kluyveri, Pichia kudriavzevii, Pichia terricola, Hanseniaspora uvarum, Hanseniaspora opuntiae/meyeri, Hanseniaspora guilliermondii, Saccharomyces cerevisiae, Cryptococcus flavescens, Aureobasidium pullulan, Wickerhamomyces sp., Starmerella bacillaris, Kluyveromyces sp., Torulaspora sp. and Satumispora diversa. In a particularly preferred embodiment the alcohol may be an alcohol produced by a live yeast selected from Hanseniaspora uvarum, Pichia kluyveri, Cryptococcus flavescens and Aureobasidium pullulan, Saccharomyces cerevisiae.

In a preferred embodiment each alcohol includes between 1 to 8 carbon atoms. In a further preferred embodiment each alcohol includes between 3 to 6 carbon atoms. In a particularly preferred embodiment the alcohol is selected from the group consisting of isoamyl alcohol, 2-methyl-1-butanol and iso-butyl alcohol; most preferably the composition includes isoamyl alcohol, 2-methyl-1-butanol and iso-butyl alcohol.

In a particularly preferred embodiment, the composition of the present invention includes one or more short chain ester(s) and one or more alcohols, wherein said composition is a liquid and/or gas mixture. In a preferred embodiment, the short chain esters are selected from the group consisting of ethyl acetate, ethyl propionate and ethyl butyrate. In a preferred embodiment, the one or more alcohols are selected from the group consisting of isoamyl alcohol, 2-methyl-1-butanol and iso-butyl alcohol. Most preferably, the composition includes ethyl acetate, ethyl propionate, ethyl butyrate, isoamyl alcohol, 2-methyl-1-butanol and iso-butyl alcohol.

In a preferred embodiment the composition includes a ratio of short chain esters to long chain esters is approximately 2:1 (based on emission rates).

In an alternatively preferred embodiment the composition includes a ratio of short chain ester to alcohol between approximately 50:1 to 70:1 (based on emission rates).

In a preferred embodiment the composition of the present invention further includes γ-decalactone.

The compositions as described herein do not exclude addition of further additives or excipients for producing a composition, apparatus or deceive suitable for attracting trapping or monitoring fruit flies.

In a further aspect of the present invention there is provided a composition for attracting fruit flies including γ-decalactone.

In a preferred embodiment the composition of the present invention includes ethyl acetate, ethyl propionate, ethyl butyrate, isoamyl alcohol, 2-methyl-1-butanol, iso-butyl alcohol and γ-decalactone.

In a preferred embodiment the composition of the present invention attracts fruit flies of the genus Bactrocera or Ceratitis. In a further preferred embodiment the fruit fly is Bactrocera tryoni, Bactrocera dorsalis or Ceratitis capitate.

In a preferred embodiment the composition of the present invention attracts female fruit flies. In a further preferred embodiment the female fruit fly is a mated female fruit fly.

In a preferred embodiment there is provided an apparatus for dispensing a composition for attracting fruit flies. In further preferred embodiment the apparatus provides for regulated release of the composition. In a further preferred embodiment the apparatus provides for regulated release of the composition for between approximately 1 to 8 weeks. In a further preferred embodiment the apparatus provides for regulated release of the composition for between approximately 2 to 4 weeks.

In a preferred embodiment there is provided an apparatus for dispensing a composition for attracting fruit flies, wherein the apparatus includes:
at least one deposit element for storage of a composition, and
at least one casing for housing a deposit element,
   wherein each deposit element releases the composition and the casing provides a means for release of the composition into the surrounding environment.

By a deposit element as used herein is meant any suitable substance which is the composition can be stored in and released from. In an embodiment the deposit element may be a cotton roll/dental wick or any other such substance suitable for storage and release of the composition.

By a casing as used herein is meant any suitable substance capable of storing the deposit element, such that it is capable of allowing for release of the composition stored within the deposit element to the surrounding environment. The release of said composition from the casing may be either passive or active.

In a preferred embodiment the casing is made of low density polyethylene. Preferably the casing has a thickness between approximately 20 μm to 300 μm, more preferably between approximately 40 μm to 250 μm. In a particularly preferred embodiment the casing has a thickness between approximately 50 μm to 225 μm.

In a preferred embodiment there is provided a device for trapping fruit flies including a composition as described herein. In an alternatively preferred embodiment there is provided a device for trapping fruit flies including an apparatus as descried herein. In a particularly preferred embodiment, there is provided a device for trapping fruit flies including an apparatus as described herein and a composition as described herein.

In a preferred embodiment the device includes a Ladd trap or any other trap system suitable for capturing fruit flies. In a further preferred embodiment the Ladd trap is modified to include holes in the half-spheres to provide a means for release of the composition from the trap. In a further preferred embodiment the Ladd trap is coated with a suitable material to trap fruit flies.

By ‘Ladd trap’ as used herein is meant a visual trap for capture of pests, consisting of a yellow backing panel (a traditional ‘sticky trap’), with a three dimensional red or dark coloured sphere (a fruit mimic) attached in the middle of the yellow panel, as described in Schutze et al. 2016. Ladd research industries are one company that manufacture such a trap.

In a preferred embodiment there is provided a method of attracting and/or trapping fruit flies including the step of exposing a fruit fly infested environment to a composition, apparatus, and/or device as described herein. In an alternative embodiment there is provided a method of monitoring for the presence of at least one fruit fly, said method including positioning a composition, apparatus, and/or device as described herein within an environment that requires monitoring for the presence of fruit flies.

In a preferred embodiment the fruit fly may be of the genus Bactrocera or Ceratitis. In a further preferred embodiment the fruit fly may be Bactrocera tryoni or Ceratitis capitata.

In an alternatively preferred embodiment the fruit fly may be Dirioxa pornia or of the genus Bactrocera, Rhagoletis or Anastrepha. In a further preferred embodiment the fruit fly may be Bactrocera aquilonis, Bactrocera bryoniae, Bactrocera frauenfeldi, Bactrocera jarvisi, Bactrocera kraussi, Bactrocera musae, Bactrocera neohumeralis, Bactrocera dorsalis, Bactrocera oleae, Bactrocera zonata and/or Bactrocera cucurbitae.

In a preferred embodiment the fruit fly may be a female fruit fly. In a particularly preferred embodiment the female fruit fly is a mated female fruit fly.

In a further aspect of the present invention there is provided a composition for attracting fruit flies including ethyl acetate, ethyl propionate, ethyl butyrate, hexylacetate, ethylhexanoate and (z)-3-hexenyl acetate.

In a further aspect of the present invention there is provided a composition for attracting fruit flies including ethyl acetate, ethyl propionate, ethyl butyrate, isoamyl alcohol, 2-methyl-1-butanol and iso-butyl alcohol.

In a further aspect of the present invention there is provided a composition for attracting fruit flies including ethyl acetate, ethyl propionate, ethyl butyrate, ethyl butyrate, hexylacetate, ethylhexanoate, (z)-3-hexenyl acetate, isoamyl alcohol, 2-methyl-1-butanol and iso-butyl alcohol.

In a further aspect of the present invention there is provided a device for trapping fruit flies, wherein said device includes:
a composition for attracting fruit flies including ethyl acetate, ethyl propionate, ethyl butyrate, hexyl acetate, ethyl hexanoate and (z)-3-hexenyl acetate; and
a Ladd trap modified to release the composition for attracting fruit flies.

In a further aspect of the present invention there is provided a device for trapping fruit flies, wherein said device includes:
a composition for attracting fruit flies including ethyl acetate, ethyl propionate, ethyl butyrate, isoamyl alcohol, 2-methyl-1-butanol and iso-butyl alcohol; and
a Ladd trap modified to release the composition for attracting fruit flies.

In a further aspect of the present invention there is provided a device for trapping fruit flies, wherein said device includes:
a composition for attracting fruit flies including ethyl acetate, ethyl propionate, ethyl butyrate, ethyl butyrate, hexylacetate, ethylhexanoate, (z)-3-hexenyl acetate, isoamyl alcohol, 2-methyl-1-butanol and iso-butyl alcohol; and
a Ladd trap modified to release the composition for attracting fruit flies.

In a further aspect of the present invention there is provided a device for trapping fruit flies, wherein said device includes:
a composition for attracting fruit flies including y-decalactone; and
a Ladd trap modified to release the composition for attracting fruit flies.

In a preferred embodiment there is provided a device for trapping fruit flies, wherein said device includes:
a composition for attracting fruit flies including y-decalactone, ethyl acetate, ethyl propionate, ethyl butyrate, isoamyl alcohol, 2-methyl-1-butanol and/or iso-butyl alcohol; and
a Ladd trap modified to release the composition for attracting fruit flies.

In this specification, the term ‘comprises’ and its variants are not intended to exclude the presence of other integers, components or steps.

In this specification, reference to any prior art in the specification is not and should not be taken as an acknowledgement or any form of suggestion that this prior art forms part of the common general knowledge in Australia or any other jurisdiction or that this prior art could reasonably expected to be combined by a person skilled in the art.

The present invention will now be more fully described with reference to the accompanying

Examples and drawings. It should be understood, however, that the description following is illustrative only and should not be taken in any way as a restriction on the generality of the invention described above.

### BRIEF DESCRIPTION OF THE DRAWINGS/FIGURES

FIG. 1. GC-MS chromatograms of yeast odours: 1a: Chromatograms of the headspace odours of gut-associated yeasts, Hanseniaspora uvarum and Pichia kluyveri grown on an orange juice agar medium. Numbers indicate compounds found only or in a markedly greater amount in H. uvarum headspace and, numbers with apostrophe show those more characteristic of P. kluyveri. 1b. SPME-GC-MS analysis of yeast volatiles showing different peak distributions (volatiles) and peak heights (relative concentrations): a) (Cryptococcus flavescens) and b) (Aureobasidium pullulans) collected from both fruits and wild-caught B. tryoni females, c) Saccharomyces cerevisiae (brewer's yeast), d) culture medium (YPD agar; control).

FIG. 2. Electrophysiological responses of Queensland fruit flies antennae (A) and palps (B) to fungal (FV) components. Graphs located on the upper part of each figure represent the electric potential of the antenna/palp. Arrows indicate points in time at which chemical stimulations are applied. Olfactory “responses” are characterised by sudden drops (spike) of the electric potential in the antenna; the amplitude of which is positively correlated to response strength. Stars indicate statistical significance of response amplitudes elicited by test compounds compared to that of the solvent (blank=paraffin oil). Bars represent the normalized responses relative to a positive control (ethyl hexanoate) of male (grey) and female (white) flies. Letters above bars indicate significant differences in response strength between each sex.

FIG. 3. An odour dispenser, comprising a heat-sealed polyethylene sachet (10) with composition infused wick (20).

FIG. 4. Modified Ladd trap design to improve odour dispensing.

FIG. 5. Mean number of Qfly adults caught in different lure traps (N=6 replicates per treatment) over two successive two-week periods following the deployment of lures prepared in sachets. The histogram of FIG. 5a represents the mean average of females caught per trap, the histogram of FIG. 5b depicts that of males, and the histogram of FIG. 5c corresponds to the mean total number of flies. SE=short ester blend, LE=long chain ester blend, fungal=fungal volatiles. Error bars represent standard errors.

FIG. 6. Mean number of mated females, virgin females, total number of females and males captured in an apple orchard per week over 8 weeks, using five trap treatments: Biotrap (treatment 1), Fruition (treatment 2), New prototype (AVR new trap; treatment 3), Fruition lure+LADD trap (treatment 4), and Protein+LADD trap (treatment 5). Treatments separated by letters as statistically significant (post-hoc Tukey's comparisons). Treatments separated by letters as statistically significant (post-hoc Tukey's comparisons).

FIG. 7. Mean number of mated females, virgin females, total number of females and males captured in a peach orchard over a 6 week period, using five trap treatments: Biotrap (treatment 1), Fruition (treatment 2), New prototype (AVR new trap; treatment 3), Fruition lure+LADD trap (treatment 4), and Protein+LADD trap (treatment 5). Treatments separated by letters as statistically significant (post-hoc Tukey's comparisons).

FIG. 8 Mean number of Qfly captured in a mixed pome fruit orchard over three weeks across three trap treatments. Treatments separated by letters as statistically significant (Post-hoc Tukey's comparisons).

### DETAILED DESCRIPTION OF THE EMBODIMENTS

### EXAMPLE 1—IDENTIFICATION OF ACETATE BASED VOLATILES

Initial studies involved investigation of the role of fruit ripening volatiles as a resource cue in a highly polyphagous tephritid, Queensland fruit fly (Qfly), Bactrocera tryoni (Froggatt) (Cunningham et al. 2016).

As with other Bactrocera flies (Cugala et al. 2014; Rattanapun et al. 2009), female B. tryoni prefer ripe fruit to unripe fruit, forming the basis for our hypothesis that ripening volatiles might be predictable indicators of a suitable host resource, rather than fruit species. We based our study on guava, Psidium guajava, as this fruit is a favored host of B. tryoni and other fruit fly species (Biasazin et al. 2014; Clarke et al. 2001). We began by confirming the preference of female (and male) flies for ripe guavas, analyzing the volatile emissions for each of the four fruit developmental stages, and guava pulp, used in our trials. We then constructed an 11-volatile synthetic odor based on the most attractive fruit ripening stage, and carried out electroantennogram (EAG) studies to confirm volatile detection at the level of the antennae. The synthetic odor was used in a series of behavioral experiments exploring the role of ripening volatiles in B. tryoni attraction, including experiments in which we injected low ranking hosts with these volatiles to investigate changes in the insects' oviposition behavior.

The three volatile esters were identified, ethyl acetate, ethyl propionate, and ethyl butyrate, that increased significantly during ripening and were highest in the overripe stage. Behavioral experiments demonstrated that these ripening volatiles attracted female flies both as a simple 3-volatile blend and as a part of a more complex 11-volatile blend based on volatiles (and their relative concentrations) in ripe guava odor.

The methods, materials and results observed in performing these experiments are described by Cunningham et al. 2016, the entirety of which is incorporated herein.

### EXAMPLE 2—IDENTIFICATION OF FUNGAL BASED VOLATILES

It was identified that yeasts that were associated with infested fruits, with female fruit flies caught in the wild, and gut-associated yeasts in wild collected larvae. Three fruit species that were heavily infested with Qfly: Vietnamese sapodilla (Manilkara zapota), white sapote (Casimiroa edulis) and woolly sapote (C. tetrameria) were investigated. Swabs were taken around Qfly oviposition puncture sites on infested fruits (stings), and from fruits with no outer signs of infestation (i.e. no sting marks). All swabs were immediately placed in sterile falcon tubes for transportation. For insect sampling, we caught eight adult female flies that were actively ovipositing on fruits. For gut-associate yeasts wild larvae were collected from ripe infested cherry plums, peaches and strawberry guava picked from trees in orchards around Victoria, to which yeasts culture, isolation, and identification was performed.

From several identified yeast species collected in the field, Cryptococcus flavescens and Aureobasidium pullulans were selected for further investigation as their presence on both female Qfly and infested fruit indicated they may be vectored by adult flies (and play a role in Qfly attraction to its host). The gut-associated yeast Hanseniaspora uvarum and Pichia kluyveri were selected as being predominant in the Qfly larvae gut, and known to produce attractants for adult insects.

An olfactory trap assay was performed on female B. tryoni flies, wherein test subject Qfly were presented with a three-way choice of odours from orange-agar substrate inoculated with either H. uvarum, P. kluyveri, or sterile orange-agar media. Significantly fewer mated female flies were caught in the H. uvarum traps compared to the orange-agar sterile control, and significantly more flies were caught in P. kluyveri traps compared to the control: thus H. uvarum emitted a deterrent odour under lab conditions, whilst P. kluyveri emitted an attractant odour. In field trials, however, H. uvarum was found to be attractive when added to traps.

The methods, materials and results observed in performing these experiments are described by Piper et al. 2017, the entirety of which is incorporated herein.

### EXAMPLE 3—ODOUR ANALYSIS

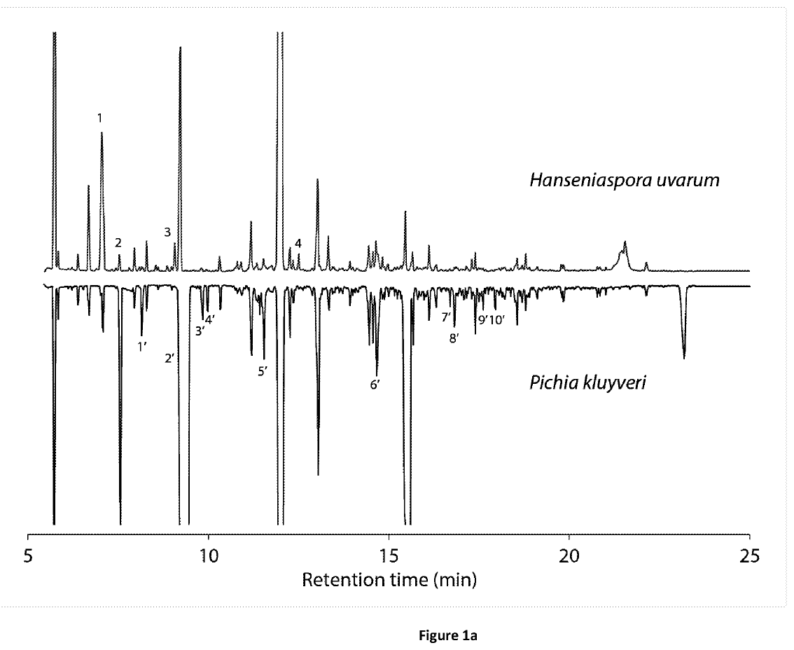

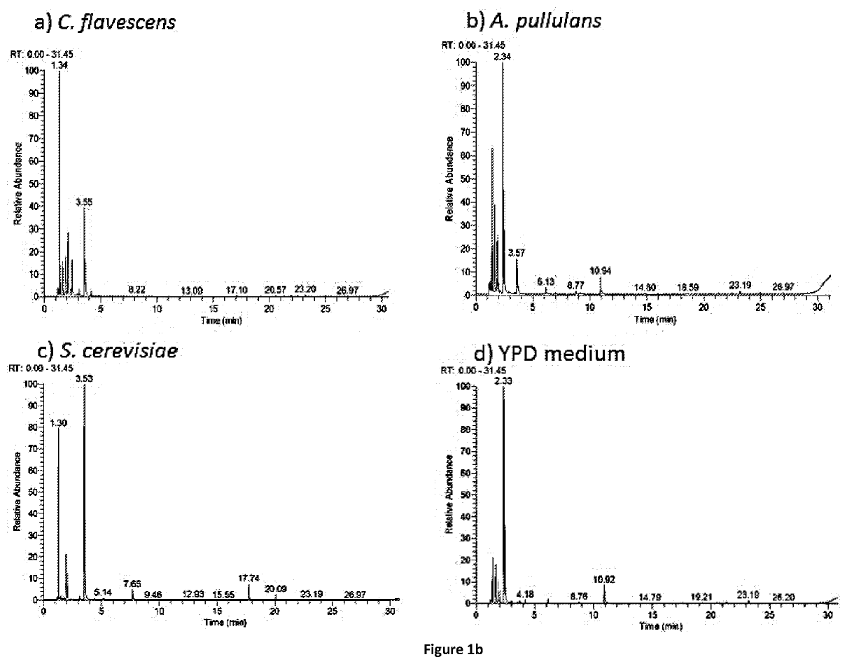

Two yeast species frequently encountered in Qfly gut (Hanseniaspora uvarum and Pichia kluyveri), as identified in Example 2, were grown on an orange juice agar medium. GC-MS volatile analysis of odour emissions was performed on these isolated yeasts, with dynamic sampling used to collect odours from the gut-associated yeasts, the results of which are shown in FIG. 1a.

Two yeast species collected from wild flies and infested fruits (C.flavescens and A. pululans), and baker's yeast (Saccharomyces cerevisiae) were all grown on YPD agar medium. GC-MS volatile analysis of odour emissions was performed on these isolated yeasts, with solid-phase microextraction (SPME) used for collecting odours from these yeasts, the results of which are shown in FIG. 1b.

Volatiles isoamyl alcohol, 2-methyl-1-butanol, and iso-butyl alcohol common to these yeasts, were selected for behavioural trials.

### EXAMPLE 4—ELECTROPHYSIOLOGICAL SCREENING

Electroantennogram (EAG) and Electropalpogram (EPG) studies (see Verschut et al. 2018 for details on materials and methods) showed strong electrophysiological responses to all three identified fungal volatiles (FV) isoamyl alcohol, 2-methyl-1-butanol, and iso-butyl alcohol.

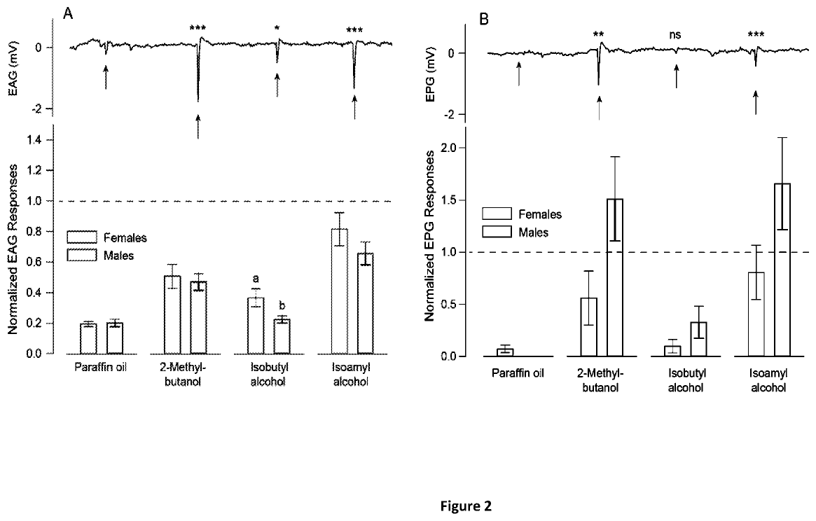

The results of these studies are shown in FIG. 2, wherein Electrophysiological responses of Queensland fruit flies antennae (A) and palps (B) to fungal (FV) components are shown. Graphs located on the upper part represent the electric potential of the antenna/palp. Arrows indicate points in time at which chemical stimulations are applied. Olfactory “responses” are characterised by sudden drops (spike) of the electric potential in the antenna; the amplitude of which is positively correlated to response strength. Stars indicate statistical significance of response amplitudes elicited by test compounds compared to that of the solvent (blank=paraffin oil). Bars represent the normalized responses relative to a positive control (ethyl hexanoate) of male (grey) and female (white) flies. Letters above bars indicate significant differences in response strength between male and female Qfly.

Two of the fungal volatiles, isoamyl alcohol and 2-methylbutanol, elicited strong responses from antennae and palps. Isobutyl alcohol, in contrast, appeared to only prompt weak and inconsistent responses inferring a higher detection threshold of this compound by Qfly.

### EXAMPLE 5—DISPENSER DESIGN

Components of the chemical blends tested in field trials were prepared in individual dispensers (‘sachets’). This dispensing method has been successfully implemented in a number of pest control and monitoring studies (Cross et al. 2006; Hall et al. 2006; Rodriguez-González et al. 2017) and is currently being used in the British monitoring program for the spotted wing drosophila (Drosophila suzukii). Sachet formulations emit relatively high quantities of volatiles for longer periods of time than achievable with other types of dispensers.

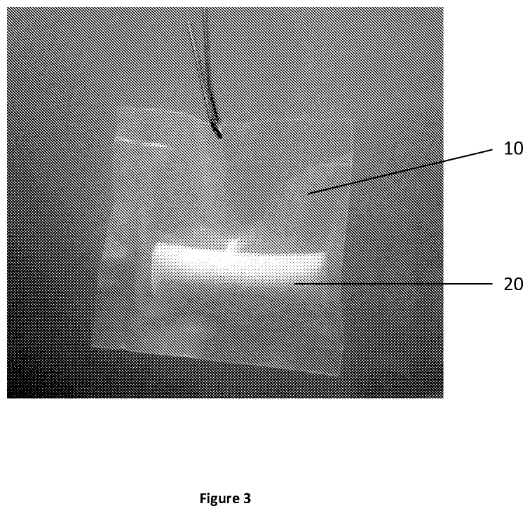

Sachets consist of plastic pouches made of Low Density PolyEthylene (LDPE) layflat tubing of determined size and thickness. Each sachet contained one or several dental wicks (approximately 4 cm length and 1 cm diameter) on which a given amount of the neat chemical compound was applied (between 0.1 and 5 g). The impregnated wick (20) was subsequently enclosed in the LDPE pouch (10) and sealed using a heat sealer (FIG. 3).

The main challenges inherent in the use of sachets lie in the physical and chemical properties of the compounds implemented in the device, and their impact on the permeation rate through the plastic membrane. In most cases, knowledge of the release rates of different chemicals in the device allows the necessary adjustments to ensure that sufficient longevity and intended ratios for different components of the blend emanate from the lures. This may enable the use of different thickness of LDPE, an increase of the amount of neat chemicals applied on dental wicks, or changes in the exchange surface area; i.e. sachet size.

Release rates of the short chain esters and fungal alcohols were investigated in a range of sachet designs. The results of this investigation are summarised in Table 1.

TABLE 1
Release rate data of compounds used in lures sachets calculated by
gravimetry under laboratory conditions (22° C., constant).

| | Release rate (mg /day) per | | | | | |
|---|---|---|---|---|---|---|
| | thickness of LDPE pouch | | | | Estimated | |
| Compound | 50 μm | 100 μm | 150 μm | 200 μm | longevity* | Treatments |
| Ethyl | 880 | 321 | 200 | 171 | ~5 days | Short chain |
| propionate | | | | | | ester |
| Ethyl | 880 | 302.7 | 180.6 | 134 | ~6 days | Short chain |
| acetate | | | | | | ester |
| Ethyl | 700 | 295 | 171 | 127 | ~6 days | Short chain |
| butyrate | | | | | | ester |
| 2-Methyl- | 16.4 | 4.1 | 2.1 | — | >1 year | Fungal |
| butanol | | | | | | alcohol |
| Isoamyl | 12 | 3 | 2 | — | >1 year | Fungal |
| alcohol | | | | | | alcohol |
| Isobutyl | 20 | 4 | 2 | — | >1 year | Fungal |
| alcohol | | | | | | alcohol |

* For standard size sachet (50 cm²); 1 ml of neat compound in each LDPE thickness

### EXAMPLE 6—TRAP DESIGN

It has previously been shown that a commercially available Ladd Trapp, consisting of a flat yellow panel (a traditional ‘sticky trap’), with a three dimensional red sphere (=a fruit mimic) attached in the middle, is attractive to adult Qfly (Schutze et al. 2016). The methods, materials and results observed in performing these experiments are described by Schutze et al. 2016, the entirety of which is incorporated herein.

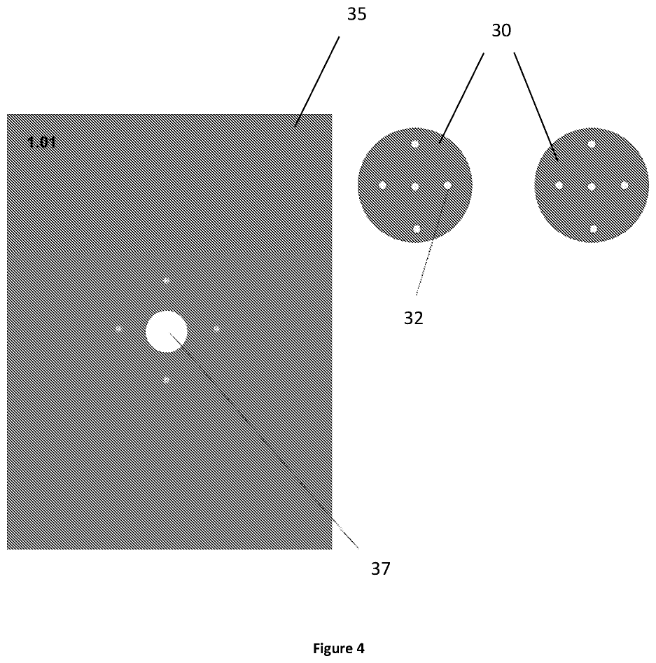

To investigate the effects of combining a known Ladd trap with the newly identified chemical combination required modifications to be made to the commercially available Ladd trap. The modified Ladd traps used in these experiments is shown in FIG. 4. Sachets dispensing individual compounds were placed inside the red sphere (30) of the Ladd traps. A 40 mm diameter hole (37) was drilled in the centre of the yellow plastic sheet (35), which was covered by the red spheres (30) to allow the odorants to diffuse on either side of the of the traps. Ten smaller holes (32), approximately 4 mm in diameter, were made in the red spheres (30). Ladd traps were coated with tangle trap prior to deployment.

### EXAMPLE 7—FIELD STUDIES EVALUATING NEW LURE FORMULATION IN CITRUS FRUIT ORCHIDS

A field study was performed in Mildura (Victoria, Australia) between February to April 2017 to evaluate the attractiveness of our three-component “base-blend”, comprising 3 short chain esters (abbreviated in figures as SE), against four newly developed formulations (full details of blend formulations and sachet dispensers used shown in Table 2). New formulations included long chain esters from ripe guava, hexyl acetate, ethyl hexanoate, (Z)-3-hexenyl acetate (abbreviated as LE), and fungal alcohol volatiles isobutyl alcohol, isoamyl alcohol, 2-methyl-1-butanol (abbreviated as FV). Table 2 details volatiles used in lures and dispensers used to control release rates.

Lures (presented in commercial Ladd traps) were tested in a citrus orchard where fruit flies were known to be present. Lures were prepared by applying neat compounds on dental rolls and subsequently enclosing in low density polyethylene (LDPE) sachets, sealed using an impulse heat sealer (FIG. 3). Sachets dispensing individual compounds were placed inside the red sphere of Ladd traps. A 40 mm diameter hole was drilled in the centre of the yellow plastic sheet (covered by the red spheres) to allow the odorants to diffuse on either side of the traps. Ten smaller holes (˜4 mm diameter) were made in the red sphere (FIG. 4). Ladd traps were coated with tangle trap prior to deployment. Traps were assessed twice a week, and lures replaced every 2 to 4 weeks.

TABLE 2
Composition of sachets for different of treatments in field study.

| Code | Treatment | Lure Composition | Sachets |
|---|---|---|---|
| A | Untreated | None - Ladd trap | n/a |
| | | only | |
| B | SE | Ethyl acetate | 1 ml on dental roll, 5 × 5 cm; |
| | | Ethyl propionate | 150 μm thick LDPE pouch |
| | | Ethyl butyrate | |
| C | SE + | Ethyl acetate | 1 ml on dental roll, 2.5 × |
| | LE (long | Ethyl propionate | 5 cm; 150 μm thick |
| | chain) | Ethyl butyrate | LDPE pouch |
| | | Hexyl acetate | |
| | | Ethyl hexanoate | |
| | | (Z)-3-hexenyl | |
| | | acetate | |
| D | SE + FV | Ethyl acetate | 1 ml on dental roll, 5 × 5 cm; |
| | (yeast) | Ethyl propionate | 150 μm thick LDPE pouch |
| | | Ethyl butyrate | |
| | | Isoamyl alcohol | 1 ml on dental roll, 7.5 × 3.3 |
| | | 2-methyl-1-butanol | cm; 100 μm thick LDPE pouch |
| | | Iso-butyl alcohol | |
| E | SE + | Ethyl acetate | 1 ml on dental roll, 5 × 5 cm; |
| | LE + FV | Ethyl propionate | 150 μm thick LDPE pouch |
| | | Ethyl butyrate | |
| | | Hexyl acetate | |
| | | Ethyl hexanoate | |
| | | (Z)-3-Hexenyl | |
| | | acetate | |
| | | Isoamyl alcohol | 1 ml on dental roll, 7.5 × 3.3 |
| | | 2-methyl-1-butanol | cm; 100 μm thick LDPE pouch |
| | | Iso-butyl alcohol | |
| F | Biotrap | Biotrap lure | N/A |
| | | (protein paste) | |

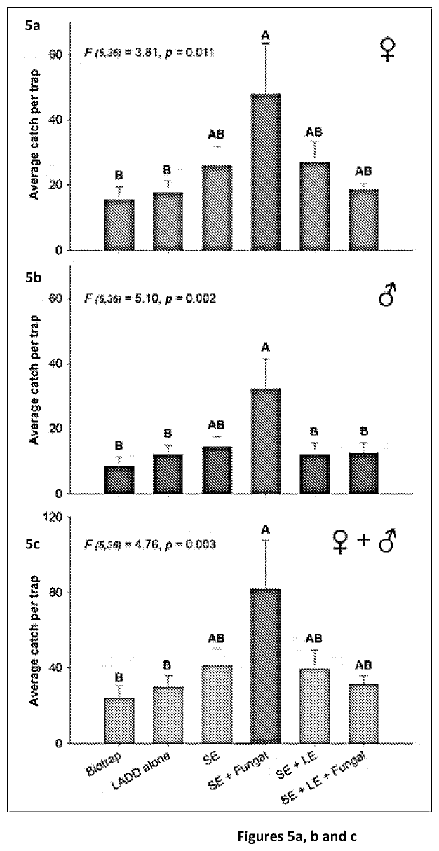

All synthetic blends were successful in attracting Qfly in the orchard, and showed promise in being more attractive than the commercially available Biotrap (protein) lure (FIG. 5). Both male and female flies were attracted to the traps, with similar responses to each of the lures. The six component lure described in this document (as SE+FV/fungal here) was the most attractive of the blends, catching over 40 female flies per trap in a 2 week period. We later assessed there to be complete loss of certain volatiles from the sachets and treatments, two weeks after lure deployment, and thus counts after this time period were not included in the dataset. The six-component SE+FV/fungal blend (3 ripening esters and 3 fungal volatiles) was thus selected as our best candidate blend for future field trials.

FIG. 5 describes the mean number of Qfly adults caught in different lure traps (N=6 replicates per treatment) over two successive two-week periods following the deployment of lures prepared in sachets. The histogram of FIG. 5a represents the mean average of females caught per trap, the histogram of FIG. 5b depicts that of males, and the histogram of FIG. 5c corresponds to the mean total number of flies. Error bars represent standard errors.

### EXAMPLE 8—FIELD STUDIES EVALUATING NEW LURE FORMULATION IN STONE FRUIT AND POME FRUIT ORCHIDS

Field trials in Victoria, Australia were conducted in pome fruit and stone fruit orchards across the state over two growing seasons (2018/19, 2019/20). The new 6-component lure was tested against commercially available lures: (i) a “fruit mimic” trap baited with synthetic fruit odours (Fruition trap, Agnova) and (ii) a trap baited with protein odours (Biotrap, Biotrap Australia). As both the physical trap (visual cues) and the odour bait differ among traps, trials used an experimental design which to some extent controlled for these factors. All orchards were biodynamic and organic, and thus insecticide use was greatly restricted.

### Trial Design and Treatments

We assessed the effectiveness of the new lure (placed within a modified Ladd trap and using newly designed dispenser technologies) against two commercial traps, Biotrap and Fruition, in four fruit orchards across Victoria between February and April 2019. All orchards were biodynamic and organic and thus insecticide use was greatly restricted. Importantly, no insecticides were applied for the duration of the study. In order to assess both the visual and odour attractant of the traps we included treatments which standardized the visual signal. We thus had five treatments:
1. Biotrap (hydrolysed proteins inside McPhail traps),
2. Fruition trap (two blue intersecting disks with synthetic fruit volatiles formulated in a gel),
3. Our protype trap (AVR new lure; SE+FV composition) and dispensers inside Ladd trap),
4. Hydrolysed protein inside Ladd traps (Ladd+Protein) and
5. Synthetic Fruition gel inside Ladd traps (Ladd+Fruition).

In treatment 3 (AVR trap), the newly designed six-component lure was presented as dispenser sachets made of low-density polyethylene containing a dental wick impregnated with a single chemical. See Table 1 for details of the individual chemicals and dispenser information. For trials in pear and apple, traps were arranged in Latin squares so that each treatment was represented once within each row and column. In the peach orchard this was not possible due to harvesting practices. Instead, traps were arranged in groups of 5 across four rows, so that each trap treatment was represented once per group and the order within each group was random. Due to variation in the size and shape of each orchard, the spacing of traps differed between crops (see Table 2 for details). Each week, captured insects were carefully removed and placed in labelled collection jars for further assessment.

The sachet employing the new lure system (SE+FV composition, treatment No. 3) as used in this trial is described in Table 3.

TABLE 3
Composition (six component blend) and dispenser information
of sachets used in stone and pome fruit trials (AVR trap).

| | | | Dental | | | | Sachet |
|---|---|---|---|---|---|---|---|
| | | | wick | | Sachet | | thick- |
| | Compound | Amount | length | | dimensions | | ness |
| Fruit | Ethyl | 1 ml | 2.5 | cm | 2.5 × 2.5 | cm | 200 μm |
| (short | propionate | | | | | | |
| esters) | Ethyl acetate | 1 ml | 2.5 | cm | 2.5 × 2.5 | cm | 200 μm |
| | Ethyl butyrate | 1 ml | 2.5 | cm | 2.5 × 2.5 | cm | 200 μm |
| Fungal | 2-methyl- | 1 ml | 5 | cm | 5 × 5 | cm | 150 μm |
| (alcohols) | butanol | | | | | | |
| | Isoamyl | 1 ml | 5 | cm | 5 × 5 | cm | 150 μm |
| | alcohol | | | | | | |
| | Isobutyl | 1 ml | 5 | cm | 5 × 5 | cm | 150 μm |
| | alcohol | | | | | | |

Flies trapped on each treatment over a 6-8 week period were counted. The sex and mating status (for females) of Qfly captured in the field trial were also established.

### Sex and Mating Status of Captured Flies

We recorded the sex of each Qfly captured in the field. Males and females were identified based on the presence or absence of an ovipositor. The mating status was also determined for females captured in traps deployed in 2019 based on the presence of sperm in the female spermatheca. Each spermatheca was carefully dissected out of the female under a dissection microscope (Leica M205C) and placed on a glass slide where it was stained with an aceto-orcein (glacial acetic acid+orcein) staining solution. Where possible both the spermatheca and the spermathecal duct were dissected together, as it was sometimes possible to see sperm along this duct. The spermatheca (and its duct) were then carefully crushed by pushing a glass cover onto the stained receptacle. The presence of sperm was then assessed under a compound microscope (Olympus BX51). Due to the high catches in the peach orchard, we subsampled by randomly selecting traps and dissecting 10 (or fewer) females until we had data for 50 females per treatment per week.

### Statistical Analysis

All statistical tests were performed using JMP 14 (JMP®, Version 15, SAS Institute Inc.). We used restricted maximum likelihood models (REML) to assess variation in the number of mated and virgin females, the total number of females and the number of males captured for traps in the apple and peach orchard. As we were unable to determine the mating status of all females captured within the peach orchard, we calculated an estimated number of mated and virgin females based on the proportion of subsampled females captured per trap treatment each week. We included trap treatment, time (week collected treated as a continuous variable), harvest (peaches only) and the interaction between trap treatment and harvest as fixed effects. Trap ID was used as a proxy for trap location and treated as a random effect. We reduced these models using hierarchical stepwise backward deletion, removing factors and interactions with p-values greater than or equal to 0.1. We subsequently used post-hoc Tukey's tests to assess differences in captures between trap treatments and its interaction with harvest. All data were log(x+1) transformed to improve variance before analysis.

### Apple Orchard

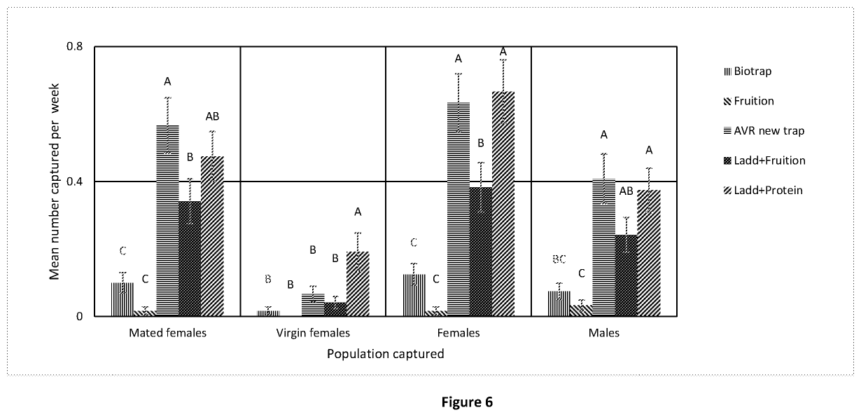

In the apple orchard, the new treatment (Table 3) captured the highest number of mated females (FIG. 6).

Ladd+Protein captured the most virgin females and the most females overall (FIG. 6). Generalized linear models revealed a significant effect of trap treatment on the number of mated females (df=4, F-ratio=15.17, p<0.0001), the number of virgin females (df=4, F-ratio=8.63, p<0.0001) and the total number of females (df=4, F-ratio=18.73, p<0.0001) captured per week. There was also a significant effect of trap treatment on the number of males captured per week (df=4, F-ratio=9.49, p<0.0001). However, there was no effect of week on the number of females (mated or virgin) or males captured (all p>0.1). Trap ID explained 2.82, 0.11, 2.59, 3.55% of the variation in the number of mated females, virgin females, total number of females and males captured respectively.

Post-hoc analyses revealed that the variation in the number of mated females captured per trap was driven by both our new trap and Ladd+Protein, capturing significantly more mated females than the Fruition and Biotrap. Additionally, our new trap captured significantly more mated females than Ladd+Fruition, but both traps were comparable to Ladd+Protein. Ladd+Protein captured significantly more virgin females compared to all other treatments.

### Peach Orchard

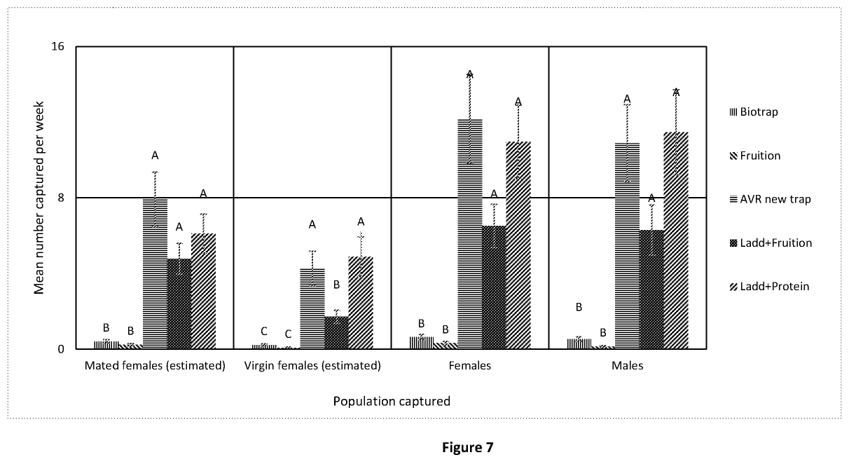

In the peach orchard the SE+FV lure inside the Ladd trap and the Protein attractant used with the Ladd traps were found to captured the most females (mated and virgin) (FIG. 7).

Ladd+Protein captured the most virgin females and males (FIG. 7). Generalized linear models revealed a significant effect of trap treatment on the number of mated females (df=4, F-ratio=37.42, p<0.0001), the number of virgin females (df=4, F-ratio=42.74, p<0.0001), the total number of females (df=4, F-ratio=40.19, p<0.0001) and the number of males (df=4, F-ratio=38.39, p<0.0001) captured per week. Post-hoc analyses revealed that the variation in the number of mated females, virgin females, the total number of females and the number of males captured per trap was driven by the trap with the new lure and dispensers (treatment 3), Ladd+Protein (treatment 5), and Ladd+Fruition (treatment 4), capturing significantly more Qfly than Fruition trap (treatment 2) and Biotrap (Treatment 1). Additionally, our new trap, and Ladd+Protein captured significantly more virgin females than Ladd+Fruition.

### EXAMPLE 9—IDENTIFICATION OF A NEW ATTRACTANT, γ-DECALACTONE, AS AN ATTRACTANT FOR FEMALE QUEENSLAND FRUIT FLY

Gas-chromatography linked to electrophysiology (GC-FID-EAD) was conducted using female B. tryoni and odours of infested yellow nectarines (collected by SPME), to identify volatiles of interest as candidate female attractants. As shown in FIG. 9, the volatile γ-decalactone evoked a significant response. γ-decalactone has previously been shown to evoke an electrophysiological response in EAG studies on Mediterranean fruit fly, Ceratitis capitata (Light et al. 1988), but not in Queensland fruit fly; and has not been demonstrated as being an attractive odour in any tephritid species to date.

### Field Study Evaluating γ-Decalactone as an Additional Attractant in the Six-Component Lure

We conducted a field study to investigate the attractiveness of γ-decalactone in a mixed pome fruit (apple and pear) orchard in March 2020. The trial compared the number of B. tryoni captured on a Ladd trap containing the six-component lure with γ-decalactone added, versus the six-component lure, and a visual control (no odours). γ-decalactone was added to the six-component blend as an additional sachet (200 μm thick and 2.5×2.5 cm) containing a dental roll (2.5 cm in length) impregnated with 1 ml γ-decalactone. Traps were deployed for 3 weeks and were arranged in Latin squares so that each treatment was represented once within each row and column. There was approximately 9 m between each trap within a row and 3m between each column. Captured B. tryoni were removed weekly.

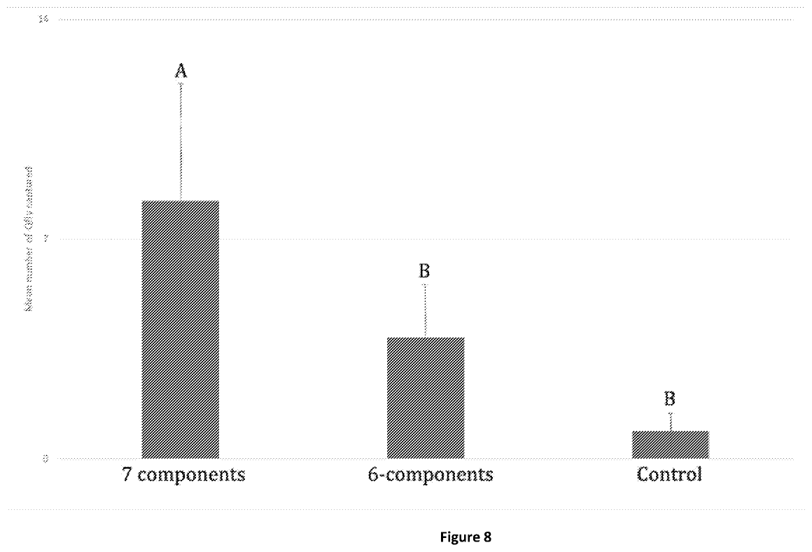

ANOVA on trap catches revealed a significant difference among treatments (df=2, F=2.38, p=0.031). The new seven component lure (six-component lure+γ-decalactone) captured twice as many Qfly as the six-component lure. (FIG. 8)

Post-hoc Tukey's test revealed that the differences in trap catches between the seven-component lure and the six-component lure were significant (p=0.048).

Finally, it is to be understood that various alterations, modifications and/or additions may be made without departing from the spirit of the present invention as outlined herein.

### REFERENCES

M. K. Schutze, B. W. Cribb, J. P. Cunningham, J. Newman, T. Peek and A. R. Clarke, 2016: ‘Ladd traps’ as a visual trap for male and female Queensland fruit fly, Bactrocera tryoni (Diptera: Tephritidae), Austral Entomology 55,324-329.
Clarke A R, Powell K S, Weldon C W, Taylor P W, 2011: The ecology of Bactrocera tryoni (Diptera: Tephritidae): what do we know to assist pest management? Ann Appl Biol 158:26-54.
Cugala D, Ekesi S, Ambasse D, Adamu R S, Mohamed S A, 2014: Assessment of ripening stages of Cavendish dwarf bananas as host or non-host to Bactrocera invadens. J Appl Entomol 138:449-457.
Rattanapun W, Amornsak W, Clarke A R, 2009: Bactrocera dorsalis Preference for and performance on two mango varieties at three stages of ripeness. Entomol Exp Appl 131:243-253.
Biasazin T D, Karlsson M F, Hillbur Y, Seyoum E, Dekker , 2014: Identification of host blends that attract the African invasive fruit fly, Bactrocera invadens. J Chem Ecol 40:966-976.
A. R. Clarke, A. Allwood, A. Chinajariyawong, R. A. I. Drew, C. Hengsawad, M. Jirasurat, C. Kong Krong, S. Kritsaneepaiboon and S. Vijaysegaran, 2001: Seasonal abundance and host use patterns of seven Bactrocera macquart species (Diptera: Tephritidae) in Thailand and peninsular Malaysia. Raffles Bull Zool 49:207-220.
J. P. Cunningham, M. A. Carlsson, T. F. Villa, T. Dekker, A. R. Clarke, 2016: Do Fruit Ripening Volatiles Enable Resource Specialism in Polyphagous Fruit Flies?, J Chem Ecol 42:931-940.
A. M. Piper, K. Farnier, T. Linder, R. Speight, J. P. Cunningham, 2017: Two Gut-Associated Yeasts in a Tephritid Fruit Fly have Contrasting Effects on Adult Attraction and Larval Survival, J Chem Ecol 43:891-901.
T. A. Verschut, K. Farnier, J. P. Cunningham and M. A. Carlsson, 2018. Behavioral and physiological evidence for palp detection of the male-specific attractant cuelure in the Queensland fruit fly (Bactrocera tryoni). Frontiers in Physiology, 9.990.
J. V. Crossa, H. Hesketha, C. N. Jaya, D. R. Hall, P J. Innocenzia, D. I. Farmanb, C. M. Burgess (2006). Exploiting the aggregation pheromone of strawberry blossom weevil Anthonomus rubi Herbst (Coleoptera: Curculionidae):Part 1. Development of lure and trap. Crop Protection 25. 144-154
D. R. Hall, A. Cork, S. J. Phythian, S. Chittamuru, B. K. Jayarama, M. G. Venkatesha, K. Sreedharan, P. K. Vinod Kumar, H. G. Seetharama, and R. Naidu (2006). Identification of components of Male-Produced Pheromone of Coffee White Stemborer, Xylotrechus quadripes. Journal of Chemical Ecology, Vol. 32, No. 1, January, 195-219.
A. Rodríguez-González, E. Sánchez-Maíllo, H. J Peláez, M. González-Núñez, D. R Hall and P. A Casqueroa (2017). Field evaluation of 3-hydroxy-2-hexanone and ethanol as attractants for the cerambycid beetle pest of vineyards, Xylotrechus arvicola. Pest Management Science. DOI 10.1002/ps.4491

1. A composition for attracting fruit flies, said composition including one or more short chain ester(s), and one or more further additives selected from:
long chain esters, and/or
alcohols,
wherein said composition is a liquid and/or gas mixture.

2. The composition according to claim 1, wherein one or more of the following applies:
i) the composition includes between 1 to 3 short chain esters;
ii) each short chain ester contains from 3 to 6 carbon atoms; and
iii) the short chain esters are selected from ethyl acetate, ethyl propionate and ethyl butyrate.

3. (canceled)

4. (canceled)

5. The composition according to claim 1, wherein one or more of the following applies:
i) the composition includes between 1 to 3 long chain esters;
ii) each long chain ester contains from 7 to 10 carbon atoms; and
iii) the long chain esters are selected from hexylacetate, ethyl hexanoate and (z)-3-hexenyl acetate.

6. (canceled)

7. (canceled)

8. The composition according to claim 1, wherein one or more of the following applies:
i) the composition includes between 1 to 3 alcohols;
ii) each alcohol includes between 1 to 8 carbon atoms; and
iii) the alcohol is selected from isoamyl alcohol, 2-methyl-1-butanol and iso-butyl alcohol.

9. The composition according to claim 1,
wherein the alcohol is produced by a yeast species.

10. The composition according to claim 9, wherein the alcohol is produced by a yeast species selected from Pichia kluyveri, Pichia kudriavzevii, Pichia terricola, Hanseniaspora uvarum, Hanseniaspora opuntiae/meyeri, Hanseniaspora guilhermondii, Cryptococcus flavescens, Aureobasidium pullulan, Wickerhamomyces sp., Starmerella bacillaris, Kluyveromyces sp., Torulaspora sp., Satumispora diversa, and Saccharomyces cerevisiae.

11. (canceled)

12. (canceled)

13. The composition according to claim 1, wherein the ratio of short chain ester to alcohol is between approximately 50:1 to 70:1 (v/v).

14. The composition for attracting fruit flies according to claim 1, wherein the composition further includes γ-decalactone.

15. (canceled)

16. The composition for attracting fruit flies according to claim 1, said composition including ethyl acetate, ethyl propionate, ethyl butyrate, isoamyl alcohol, 2-methyl-1-butanol and iso-butyl alcohol and optionally γ-decalactone.

17. (canceled)

18. (canceled)

19. (canceled)

20. (canceled)

21. (canceled)

22. (canceled)

23. (canceled)

24. An apparatus for dispensing the composition according to claim 1.

25. (canceled)

26. The apparatus according to claim 24, wherein the apparatus provides for regulated release of the composition for between approximately 1 to 8 weeks.

27. The apparatus according to claim 24, wherein the apparatus includes:
at least one deposit element for storage of a composition, and
at least one casing for housing a deposit element,
wherein each deposit element releases the composition and the casing provides a means for release of the composition into the surrounding environment.

28. The apparatus according to claim 27, wherein the casing is made of low density polyethylene having a thickness between approximately 20 μm to 300 μm.

29. A device for trapping fruit flies including the composition according to claim 1.

30. (canceled)

31. The device according to claim 29, wherein the device includes a Ladd trap.

32. The device according to claim 31, wherein one or both of the following applies:
i) the Ladd trap is modified to include holes to provide a means for release of the composition from the device; and
ii) the Ladd trap is coated with a suitable material to trap fruit flies.

33. (canceled)

34. (canceled)

35. The device for trapping fruit flies according to claim 29, wherein said device includes:
a composition for attracting fruit flies including ethyl acetate, ethyl propionate, ethyl butyrate, isoamyl alcohol, 2-methyl-1-butanol and iso-butyl alcohol and optionally γ-decalactone; and
a Ladd trap modified to release the composition for attracting fruit flies.

36. (canceled)

37. (canceled)

38. (canceled)

39. A method of attracting and/or trapping fruit flies including the step of exposing a fruit fly infested environment to a device according to claim 29.

40. A method of monitoring for the presence of at least one fruit fly including positioning a device according to claim 29, within an environment that requires monitoring for the presence of fruit flies.

41. The method of claim 39, wherein one of the following applies:
i) the fruit fly is Dirioxa porni, or of the genus Bactrocera or Ceratitis, Rhagoletis or Anastrepha;
ii) the fruit fly is of the species Bactrocera tryoni, Bactrocera dorsalis or Ceratitis capitate;
iii) the fruit fly is a female fruit fly; and
iv) the fruit fly is a mated female fruit fly.

42. The method of claim 40, wherein one of the following applies:
i) the fruit fly is Dirioxa porni, or of the genus Bactrocera or Ceratitis, Rhagoletis or Anastrepha;
ii) the fruit fly is of the species Bactrocera tryoni, Bactrocera dorsalis or Ceratitis capitate;
iii) the fruit fly is a female fruit fly; and
iv) the fruit fly is a mated female fruit fly.
